(19) United States
(12) Patent Application Publication
(10) Pub. No.: US 2001/0013698 A1
(43) Pub. Date: Aug. 16, 2001

(54) Children's book with dispenser

(75) Inventor: Albert Soussan, Montreal (CA)

Correspondence Address: Mr. Allison C. Collard, Collard & Roe, P.C., 1077 Northern Boulevard, Roslyn, NY, 11576, US

(73) Assignee: EDITIONS PHIDAL INC.

(21) Appl. No.: 09/781,508

(22) Filed: Feb. 12, 2001

(30) Foreign Application Priority Data
Feb. 14, 2000 (CA) 2,298,383

(51) Int. Cl. B42D 1/00

(52) U.S. Cl. 281/15.1; 281/22; 281/29; 281/31

(57) ABSTRACT

A children's book with a dispenser for candy pieces or the like is provided. The book has a plurality of assembled pages and has a recess in its top corner. A spine is provided for binding the pages together, and a hollow container with a top opening and top lid is affixed along the spine. The container may act as a candy dispenser. a top ornament is mounted over the top lid and partially extends in the recess.

### FIELD OF THE INVENTION

The present invention relates to the field of children's books and more particularly concerns a book provided with a dispenser for candy or the like.

### DESCRIPTION OF THE PRIOR ART

The prior art teaches a variety of constructions for books and holders. For example, U.S. Pat. No. 1,848,980 (WALKER) shows a safety pencil holder that is attached to the back of a book, and comprises a resilient receptacle and a closure. In addition, U.S. Pat. No. 5,368,333 (ARROYO) shows a loose leaf binder having a storage compartment provided with a lid along the spine thereof. Both of these patents however teach devices designed to jointly store paper and writing supplies and are not concerned with the entertainment value of the resulting product.

U.S. Pat. No. 5,681,199 (MORRIS) shows a children's book having a spine, a housing set along the spine and a toy placed inside the housing. An activating device is provided to extend the toy figure within the conduit using the bottom portion of this toy. However, the conduit cannot be used for storage. In addition, the toy figure, when extended, projects over the top edge of the book, making it difficult to store the book on bookshelves when in this state. If the figure is retracted inside the conduit before shelving, it is then not visible at all.

### SUMMARY OF THE INVENTION

The present invention therefore provides a chidren's book, having a plurality of pages. Each page has a top edge, a side edge and an inward corner edge joining the extremities of the top and side edges. The pages are assembled to form the book, with the corner edges superposed to define a recess in the book.

The book further includes a spine attached to the side edge of each page, for binding the pages together. A hollow container is affixed along the spine The hollow container has a top opening and an openable top lid for covering this top opening. A top ornament is mounted over the top lid, and partially extends in the recess.

In accordance with a preferred embodiment of the present invention, there is also provided a book and candy kit, including a book as described above and a plurality of candy pieces. Each of the candy pieces is insertable inside the hollow container.

The present invention and its advantages will be better understood upon reading the following description of preferred embodiments thereof with reference to the enclosed drawings.

### BRIEF DESCRIPTION OF THE DRAWINGS

FIG. 1 is a perspective view of the book of the present invention, where the top lid is closed.

FIG. 2 is a perspective view of the book of FIG. 1, where the top lid is open.

### DESCRIPTION OF PREFERRED EMBODIMENTS OF THE INVENTION

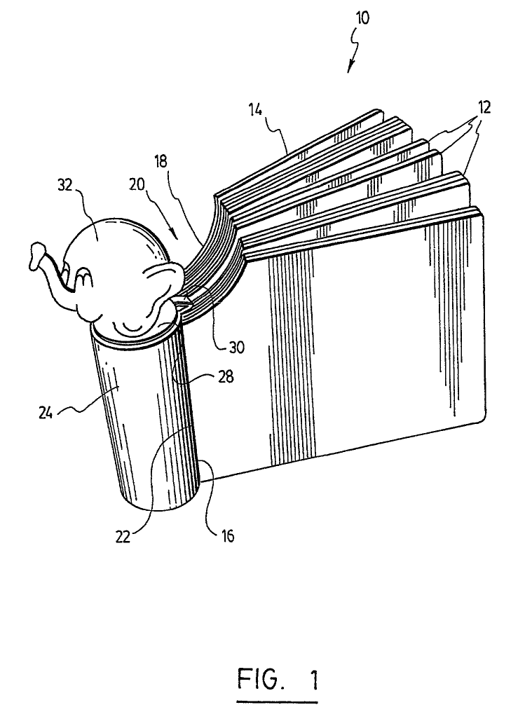

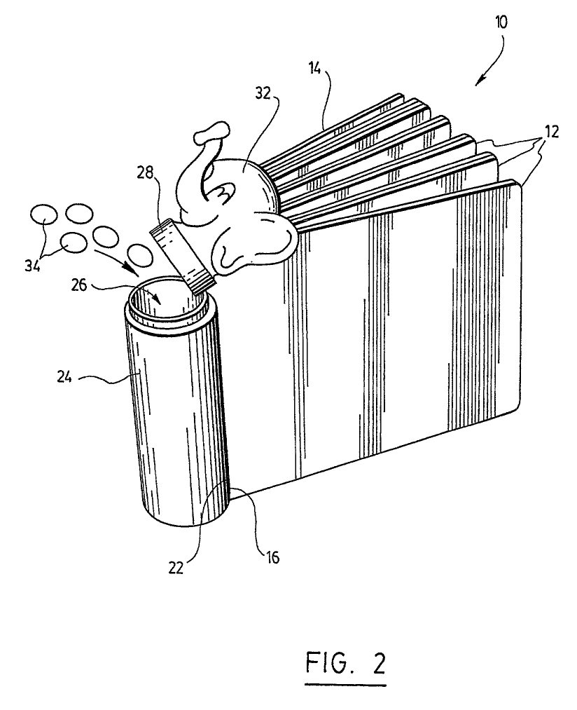

Referring to FIGS. 1 and 2, there is shown a book 10 according to a preferred embodiment of the present invention. Preferably, the book 10 is a children's book.

The book 10 has a plurality of assembled pages 12. In the preferred embodiment, the pages 12 are made of a rigid material such as laminated cardboard. Alternatively, the pages could be simply made of paper, or the middle pages could be made of paper with rigid front and back covers. Each page 12 has a top edge 14, a side edge 16 and an inward corner edge 18 joining the extremities of the top and side edges 14 and 16. The corner edges 18 preferably have a rounded shape. The superposed corner edges 18 define a recess 20 in the top corner of the book when the pages 12 are assembled.

A spine 22 is attached to the side edge 16 of each page 12, for binding the pages 12 together. The spine may be of any type appropriate to bind together the pages of the chosen material and of course should allow for the book to be opened and the pages turned. A hollow container 24 is affixed along said spine, and is preferably of the same length as the side edges 16, so that its top and bottom ends extend flush with the extremities of the sides edges 16. The shape of the hollow container 24 is preferably cylindrical, and in the preferred embodiment is made of plastic, although any other convenient material could be used. The hollow container 24 has a top opening 26 and is provided with an openable top lid 28 for covering the top opening 26. Preferably, a hinge 30 attaches the top lid 28 to the hollow container 24. In the illustrated embodiment, the hinge 30 is simply embodied by a folded length of plastic integral to both the container 24 and the lid 28. The hinge 30 herein is shown as projecting inside the recess 20, so that the lid 28 opens toward the recess 20, but could have in any other orientation.

In the preferred embodiment, the hollow container 24 is used as a dispenser for candy pieces 34. Other types of accessories could be inserted therein, eatable or otherwise.

A top ornament 32 is mounted over the top lid 28, and partially extends in the recess 20. Preferably, the top ornament 32 is a representation of a head of a character depicted in the book. Also preferably, the ornament 32 is rotationally mounted on the top lid 28. This is particularly advantageous when the ornament depicts a character that can be turned, for example, to face the front of the book when in its wrapping, the inside of the book to be seen in the recess when the book is read, the outside of the book, to be visible when the book is stored on a bookshelf, and so on. The top ornament 32 is preferably made of rubber, but could be made of plastic or any other appropriate material.

Advantageously, the top ornament may be sized so as to not rise substantially above the top edge of the book, while still being visible from both the outside and the inside of the book. In addition, the provision of the recess 20 allows for the pages 12 to be flipped without interference form the ornament 32.

In accordance with the preferred embodiment of the invention, there is also provided a book and candy kit, including a book 10 as described above and a plurality of candy pieces 34 insertable inside the hollow container. The kit may be sold with the candy already inserted in the container or provided on the side. The hollow container then acts as a candy dispenser.

Of course, numerous changes could be made to the embodiments described above without departing from the scope of the invention as defined in the appended claims.

What is claimed is:

1. A book, comprising:
a plurality of pages, each having a top edge, a side edge and an inward corner edge joining extremities of said top and side edges, the pages being assembled to form said book with said corner edges superposed to define a recess in said book;
a spine attached to the side edge of each page for binding together the pages;
a hollow container affixed along said spine, said hollow container having a top opening and an openable top lid for covering said top opening; and
a top ornament mounted over said top lid and partially extending in the recess.

2. A book according to claim 1, wherein said corner edge has a rounded shape.

3. A book according to claim 1, wherein the top ornament is rotationally mounted over the top lid.

4. A book according to claim 1, wherein the top ornament is a representation of a head of a character.

5. A book according to claim 1, wherein the top ornament is made of rubber.

6. A book according to claim 1, wherein the hollow container has a cylindrical shape.

7. A book according to claim 1, wherein the hollow container is made of plastic.

8. A book according to claim 1, further comprising a hinge attaching the top lid to the hollow container.

9. A book according to claim 8, wherein said hinge projects inside the recess.

10. A book according to claim 1, wherein each of the pages is made of laminated cardboard.

11. A book and candy kit, comprising:
a book according to claim 1; and
a plurality of candy pieces, each of said candy pieces being insertable inside the hollow container.
